(19) United States
(12) Patent Application Publication
(10) Pub. No.: US 2016/0291841 A1
(43) Pub. Date: Oct. 6, 2016

(54) MOBILE DEVICE EMULATING A FIELD DEVICE DISPLAY

(71) Applicant: Honeywell International Inc., Morristown, NJ (US)

(72) Inventors: CHANDRASEKAR REDDY MUDIREDDY, HYDERABAD (IN); SURESH KUMAR PALLE, BANGALORE (IN); JAGANMOHAN Y. REDDY, HYDERABAD (IN)

(21) Appl. No.: 14/677,657

(22) Filed: Apr. 2, 2015

(51) Int. Cl. G06F 3/0484; G06F 3/0481; G06F 3/02

(52) U.S. Cl. CPC G06F 3/04842; G06F 3/0227; G06F 3/0481

(57) ABSTRACT

A method and mobile device for emulating a field device display of a field device within an industrial process facility. A processor executes a display emulation program that implements a method of wirelessly sending a request for current information describing current display features displayed on a field device display (FDD). The current display features include at least one display window having graphical unit interface (GUI) process data therein associated with the field device, at least one user control for controlling the field device and placement information defining locations on the FDD for the display window, the GUI process data and the user control. The method further includes wirelessly receiving the current display features from the field device. The method further includes displaying the display window including the GUI process data and the user control in respective locations on the mobile display based on the placement information.

### FIELD

Disclosed embodiments relate to process facilities that use field devices to monitor and control process facility operations. More specifically, disclosed embodiments relate to a mobile device and method for emulating a field device display of a field device within an industrial process facility.

### BACKGROUND

Process facilities are used in various industries such as petroleum or chemical refining, pharmaceutical, pulp and paper, or other manufacturing operations. Process facilities use process control systems including various field devices to measure and sense process parameters. The field devices can include tank level gauges, temperature sensors, pressure sensors, valve controllers and other devices. Field devices are frequently located in locations where they are difficult to access. For example, a field device can be located at the top of a storage tank where the only access to the device is by an operator climbing a ladder.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments include a method for emulating a field device display of a field device within an industrial process facility. The method includes providing a mobile device including a mobile display, a transceiver coupled to an antenna, a non-transitory machine readable storage device (memory device), and at least one processor coupled to the mobile display and the transceiver. The memory device stores a display emulation program implemented by the processor. The display emulation program implements wirelessly sending a request for current information describing display features (current display features) displayed on a field device display (FDD) of a field device within an industrial process facility. The display features include at least one display window having graphical unit interface (GUI) process data therein associated with the field device, at least one user control for controlling the field device and placement information defining locations on the FDD for the display window, the GUI process data, and the user control. The method also includes wirelessly receiving the current display features from the field device. The method further includes displaying the display window including the GUI process data therein and the user control in respective locations on the mobile display based on the placement information.

Disclosed embodiments also include a mobile device that includes a mobile display, a transceiver coupled to an antenna and at least one processor coupled to the mobile display and the transceiver. The mobile device further includes a memory device coupled to the processor. The memory device stores a display emulation program implemented by the processor. The display emulation program causes the processor to wirelessly send a request for current information describing display features (current display features) displayed on a field device display (FDD) of a field device within an industrial process facility. The display features include at least one display window having GUI process data therein associated with the field device, at least one user control for controlling the field device, and placement information defining locations on the FDD for the display window, the GUI process data, and the user control. The processor wirelessly receives the current display features from the field device. The processor displays the display window including the GUI process data therein and the user control in respective locations on the mobile display based on the placement information.

### BRIEF DESCRIPTION OF THE DRAWINGS

FIG. 1 is a block diagram of an example mobile device and process facility including a field device, according to an example embodiment.

FIG. 2 is a front view of a FDD of a field device and a mobile device display of a mobile device which emulates the display details displayed by the FDD, according to an example embodiment.

FIG. 3 is a block diagram of a mobile device, according to an example embodiment.

FIG. 4 is a flow chart that shows steps in an example method of emulating field device displays and field device user input devices on a mobile device, according to an example embodiment.

FIG. 5 is a flow chart that shows steps in an example method of a user selecting field device settings using a mobile device, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

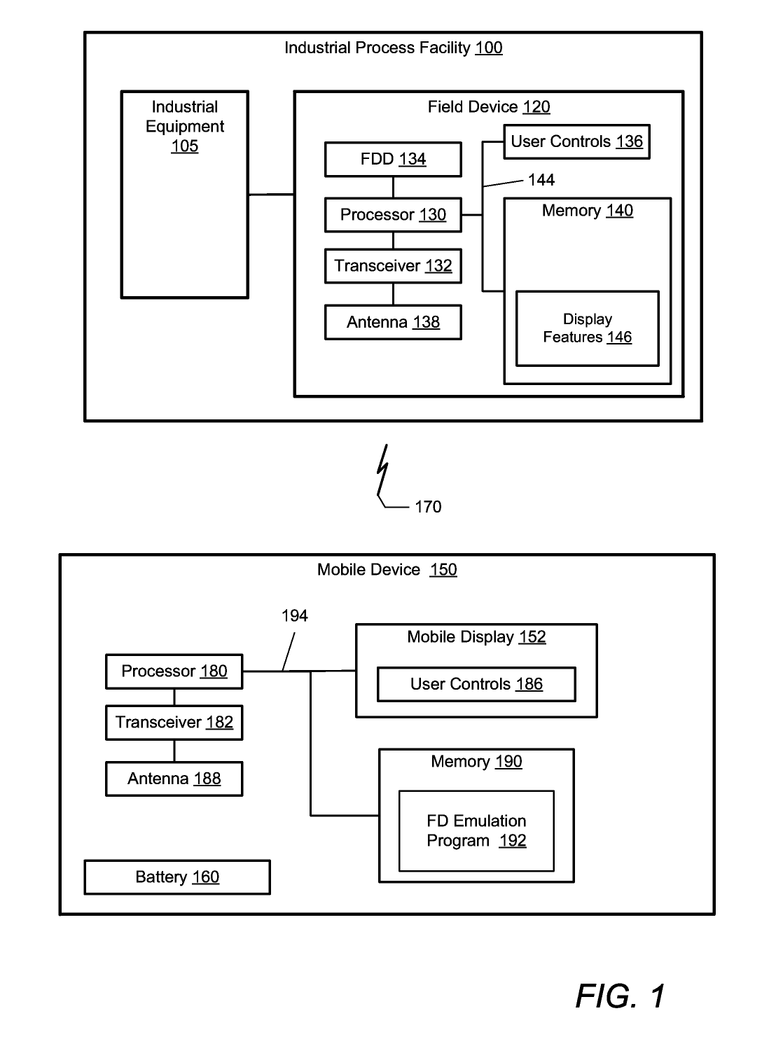

FIG. 1 illustrates a block diagram of an example industrial process facility (IPF) 100. IPF 100 can be a variety of manufacturing plants or storage locations that handle, process, store and transport a powder, liquid or fluid material. IPF 100 can include manufacturing plants, chemical plants, crude oil refineries, ore processing plants, paper manufacturing plants, water processing plants and tank farms. These industries and facilities typically use continuous processes and fluid processing.

IPF 100 comprises industrial processing equipment (industrial equipment) 105 such as mixers, furnaces and combustors, and one or more field devices 120 coupled to the industrial equipment 105. Field devices 120 are mounted to or are in communication with industrial equipment 105 such as industrial control devices or function as measurement devices within IPF 100. Field devices 120 measure, sense, control and record the flow and movement of materials within industrial equipment 105. For example, field devices 120 can measure temperature, pressure and volume. Other field devices 120 can control the operation of valves and switches to regulate the flow of fluids or gases. As noted above, field devices such as field device 120 are frequently located in locations in the IPF 100 where they are difficult to access. For example, a field device can be located at the top of a storage tank where the only access to the field device is by an operator climbing a ladder.

Field device 120 includes a computing device such as a processor 130 (e.g., digital signal processor (DSP), microprocessor or microcontroller unit (MCU)) having an associated memory 140. The field device 120 does not need any special programming to implement disclosed embodiments. Processor 130 is also coupled to a transceiver 132 and includes a field device display (FDD) 134. Transceiver 132 is connected to antenna 138. Transceiver 132 can transmit and receive wireless signals shown as 170. Field device 120 can be an RF device, a Bluetooth device, a near field communication device or an infrared device.

FDD 134 can be a wide variety of different display types including video displays, mechanical displays, mechanical gauges, electro-luminescent displays and light emitting diodes (LED) displays. FDD 134 can provide visual information to a user such as parameters, data, alarms, symbols and alerts. Memory 140 also stores display features 146 that are shown on FDD 134. In one embodiment, processor 130 can update the display features 146 in real-time. Processor 130 is further coupled to user controls 136. User controls 136 can be a wide variety of controls including user input devices such as buttons, rotary switches, rotary and linear potentiometers, touch pads, touch sensitive screens and joysticks. In one embodiment, user controls 136 can include touch sensitive regions displayed on the FDD 134. Processor 130 is coupled to memory 140 and user controls 136 via a data bus 144.

A disclosed mobile device 150 can be used to emulate the FDD 134 including the display window(s) having GUI process data therein and user controls 136 of the field device 120. Mobile device 150 includes a processor 180 (e.g., DSP, microprocessor or MCU) having an associated memory 190 that stores a field device emulation (FD emulation) program 192. Processor 180 is also coupled to a transceiver 182, which as used herein can include a separate transmitter and receiver. Transceiver 182 is connected to antenna 188. Processor 180 is coupled to mobile display 152. Mobile display 152 can include user controls 186. In one embodiment the mobile display 152 includes a touch sensitive screen.

Processor 180 can perform any one or more of the emulation-related operations, applications, or the emulation methodologies-related described herein. Processor 180 is further coupled to user controls 186. Processor 180 implements the FD emulation program 192 which initiates wireless communications using wireless signals 170 with the field device 120 to enable emulating the display features 146 and user controls 136 on FDD 134 on the mobile display 152. User controls 186 copy user controls 136 of the field device 120 by providing a representation thereof (touch sensitive buttons) which as noted above can be a wide variety of controls including user input devices such as buttons, rotary switches, rotary and linear potentiometers, touch pads, touch sensitive screens and joysticks. Processor 180 is coupled to user controls 186 via a system bus 194.

The mobile device 150 can send a wireless request for current information describing display features (current display features) displayed on FDD 134. The display features include at least one display window having GUI process data therein associated, at least one user control for controlling the field device, and placement information defining locations on the FDD 134 for the display window(s) and user controls. The current display features from the field device 120 as noted above are wirelessly received by the mobile device 150 upon an authenticated request, which then displays the display window including the GUI process data therein and a representation of the user controls (user controls 186) in respective locations on the mobile display 152 based on the placement information.

In one embodiment wireless signals 170 used can be encrypted. For example, the operation of a cipher as known in encryption depends auxiliary information, commonly referred to as a “key”. The encrypting procedure is varied depending on the key, which changes the detailed operation of the encrypting algorithm. A key is generally selected before using a cipher to encrypt a message. Without knowledge of the key, it is generally impossible to decrypt the resulting ciphertext into readable plaintext. In this embodiment, the mobile device 150 is provided the key.

Mobile device 150 is a lightweight, portable, handheld, self-powered unit that can be readily transported by a user for use throughout industrial process facility 100. In one embodiment, mobile device 150 can be a laptop computer, a tablet computer, a notebook computer or a smart phone. Battery 160 can supply power to mobile device 150. In one embodiment, mobile device 150 can be powered via a utility power source (mains powered).

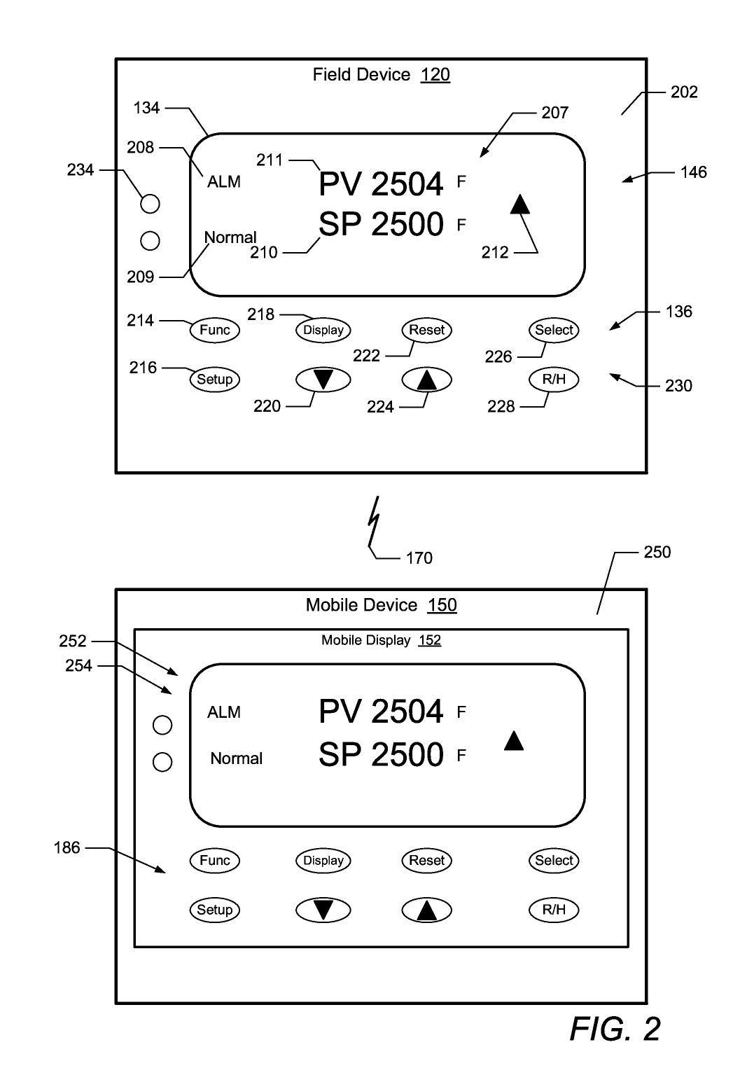

FIG. 2 illustrates further display details of a FDD 134 of a field device 120 and the mobile display 152 of mobile device 150 which emulates the display details displayed by the FDD 134 including the display window(s) having GUI process data therein associated with the field device, and provides a representation of the user controls 136. Field device 120 includes a front panel 202 having FDD 134. FDD 134 includes several display features (current display features) 146 that are viewable by a user. FDD 134 is mounted to front panel 202. Various process data 207 about industrial equipment 105 can be shown on FDD 134. For example, FDD 134 can show an alarm 208, a status or event indicator 209, a present value temperature 211, a setpoint temperature 210 and an indicator 212 of the direction of change of the temperature.

Current display features 146 further include several user controls 136 for controlling the field device 120 that are mounted to front panel 202. User controls 136 can be a wide variety of controls including user input devices such as buttons, rotary switches, rotary and linear potentiometers, touch pads, touch sensitive screens and joysticks. User controls 136 can include a function button 214, a setup button 216, a display button 218, a down select button 220, a reset button 222, an up select button 224, a select button 226 and a run/hold button (R/H) 228. Current display features 146 further include several visual indicators such as light emitting diodes (LED) 234. Placement information 230 can be defined for the current display features 146 on front panel 202. Placement information 230 defines the physical coordinates or locations for the display window(s) having GUI process data therein associated with the field device and for the user controls 136.

Mobile device 150 includes a front panel 250 having a mobile display 152 mounted thereon. As noted above, the mobile device's receipt of requested information from the field device 120 enables the mobile display 152 to emulate the FDD 134 including the display window(s) having GUI process data therein associated with the field device, a representation of the user controls 136 of the field device 120. Mobile display 152 has a display window 252 shown including GUI data 254 that matches that shown on the FDD 134 and provides a representation for the user controls 186 that matches the function of the user controls 136 including the same respective locations on the mobile display 152 based on the placement information 230 regarding the FDD 134 and user controls 136 received from the field device 120. The functional information for user controls 136 can be wirelessly received by mobile device 150 only once with the initial request response which can be received along with the current display features 146 and placement information 230 provided with typical request responses.

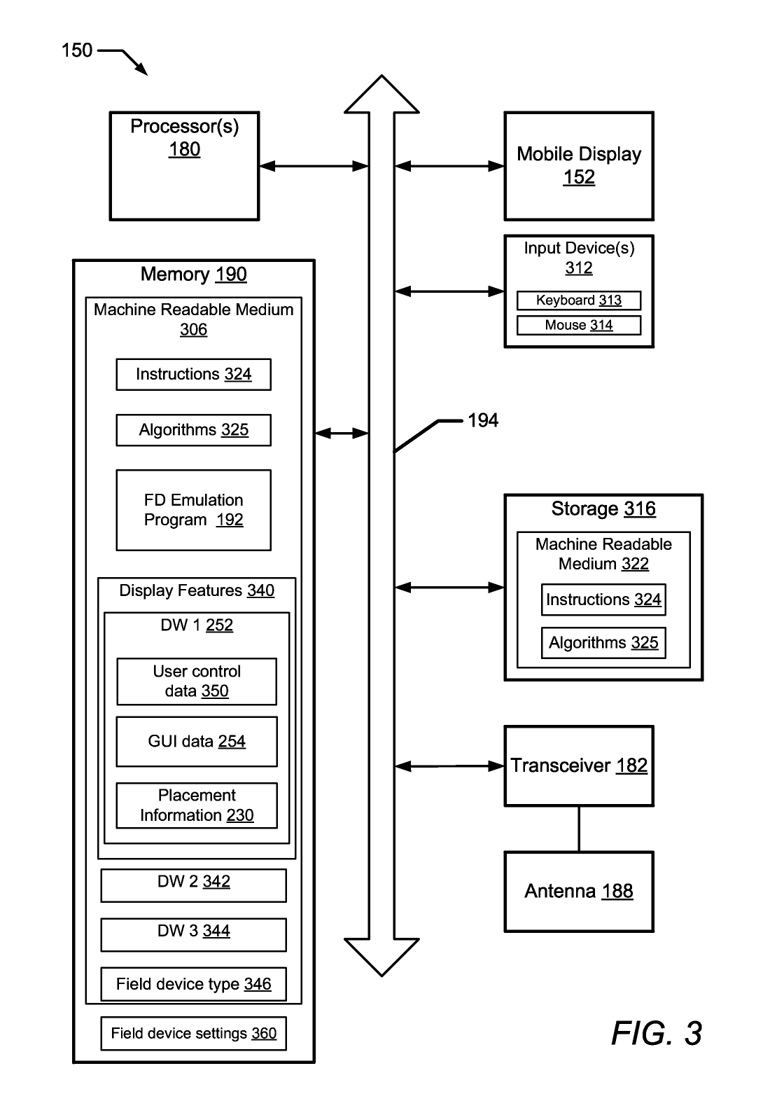

FIG. 3 illustrates an example block diagram of mobile device 150 within which a set of instructions 324 and/or algorithms 325 can be executed causing the mobile device 150 to perform any one or more of the emulation-based methods, processes, operations, applications, or methodologies described herein.

Mobile device 150 includes one or more processors 180 such as a central processing unit (CPU) and a storage device such as memory 190, which communicate with each other via system bus 194 which can represent a data bus and an address bus. Memory 190 includes a machine readable medium 306 on which is stored one or more sets of software such as instructions 324 and/or algorithms 325 embodying any one or more of the methodologies or functions described herein. Memory 190 can store instructions 324 and/or algorithms 325 for execution by processor 180. The mobile device 150 further includes a mobile display 152 such as a touch sensitive screen that is connected to system bus 194. The mobile device 150 also has input devices 312 such as an alphanumeric input device (e.g., keyboard 313) and a cursor control device (e.g., a mouse 314) that are connected to system bus 194.

A storage device 316, such as a hard drive or solid state drive, is connected to and in communication with the system bus 194. The storage device 316 includes a machine readable medium 322 on which is stored one or more sets of software such as instructions 324 and/or algorithms 325 embodying any one or more of the methodologies or functions described herein. The instructions 324 and/or algorithms 325 can also reside, completely or at least partially, within the memory 190 and/or within the processor 180 during execution thereof. The memory 190 and the processor 180 also contain machine readable media.

While the machine readable medium 322 is shown in an example embodiment to be a single medium, the term “machine readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding or carrying a set of instructions for execution by the computer system and that cause the computer system to perform any one or more of the methodologies shown in the various embodiments of the present invention. The term “machine readable medium” shall accordingly be taken to include, but not be limited to, solid-state memories, optical and magnetic media, and carrier wave signals.

Mobile device 150 further includes a transceiver 182 (which as used herein can include a separate transmitter and receiver) connected to system bus 194. Transceiver 182 is connected to antenna 188. Transceiver 182 can transmit and receive wireless signals 170. As noted above mobile device 150 can be an RF device, a Bluetooth device, a near field communication device, or any device suitable for transmitting and receiving wireless signals.

Machine readable medium 306 can further store FD emulation program 192. FD emulation program 192, when executed by processor 180 emulates FDD 134 and user controls 136 of field device 120 onto mobile display 152 of mobile device 150.

Machine readable medium 306 further stores display features 340 shown on field device 120. Current display features 146 are received from field device 120 and then stored as display features 340 to memory 190. Display features 340 include one or more display windows (DW) including DW 1 252, DW 2 342 and DW 3 344. DW 1 252 includes GUI data 254 including user control data 350 and placement information 230. Display features 340 also include one or more field device types 346 that are obtained from data associated with the display features 146. Field device types 346 include data and information regarding the capabilities of field device 120.

Machine readable medium 306 further stores field device settings 360. Field device settings 360 are user selected values input by user on mobile device 150 for transmission to field device 120. After transmission of the field device settings 360 to field device 120, field device 120 changes any one of user controls 136 or other parameters to match the selected field device settings. In one embodiment, field device settings 360 are selected by a user using a touch sensitive screen such as mobile display 152.

In one embodiment, memory 190 stores FD emulation program 192 implemented by the processor 180. The FD emulation program implements wirelessly sending a request for current information describing display features (current display features 146) displayed on field device 120 within IPF 100. The display features include at least one display window DW 1 252 having GUI data 254 therein associated with the field device, at least one user control data 350 for controlling the field device and placement information 230 defining locations on the FDD for the display window, the GUI process data and the user control. The method also includes wirelessly receiving the current display features from the field device. The display window 252 is displayed, including the GUI process data therein and the user control data in respective locations on the mobile display 152, based on the placement information 230.

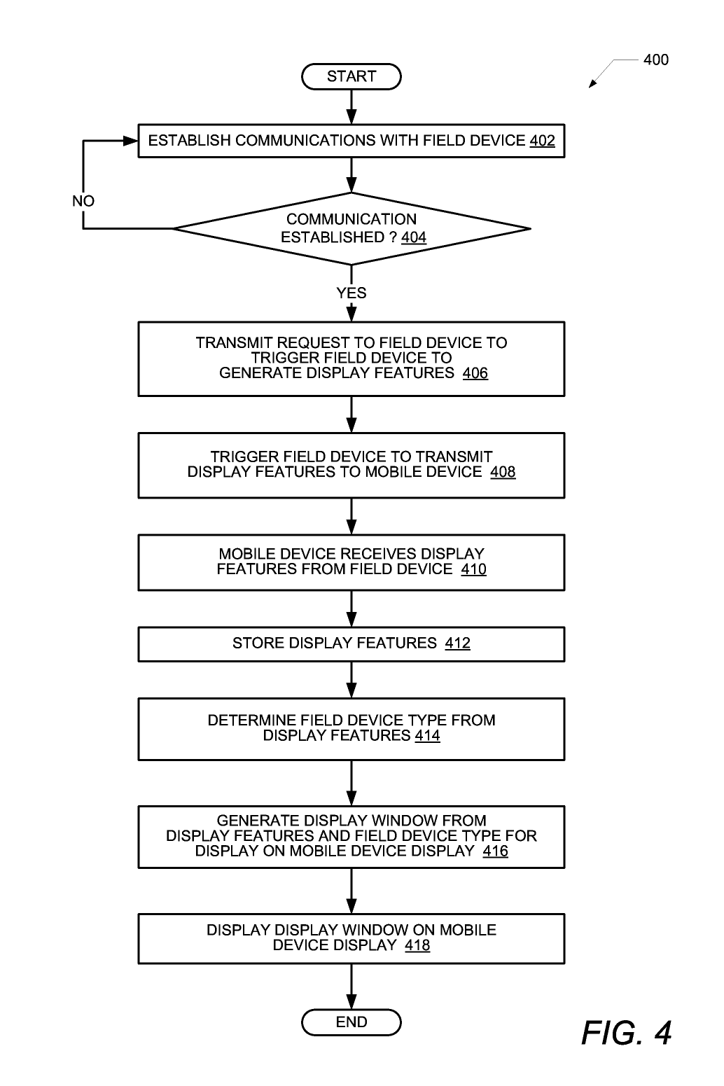

FIG. 4 provides a flow chart showing steps in an example method 400 for emulating the FDD 134 and user controls 136 on mobile device 150. Method 400 can be implemented via the execution of instructions 324 and/or algorithms 325 by processor 180 within mobile device 150 and specifically by the execution of FD emulation program 192 by processor 180. Method 400 begins at the start block and proceeds to block 402 where processor 180 establishes communications with field device 120. Processor 180 causes transceiver 182 to transmit a request to establish communications with field device 120. In one embodiment, the request further includes a security feature such as requestor identification information where field device 120 only responds to requests from a stored list of known requestor mobile devices 150.

At decision block 404, processor 180 determines if communications have been established with field device 120. In response to communications not being established with field device 120, method 400 returns to block 402 to continue attempting to establish communications with field device 120. In response to communications being established with field device 120, processor 180 wirelessly sends to field device 120 a request for current information describing display features (current display features 146) displayed on FDD 134 and user controls 136 of field device 120 (block 406). The request triggers processor 130 of field device 120 to generate current display features 146. The display features 146 include data for FDD 134, user controls 136 and placement information 230. The request further triggers processor 130 to wirelessly transmit, via transceiver 132 and wireless signal 170, the current display features 146 to mobile device 150 (block 408).

At block 410, mobile device 150 wirelessly receives the current display features 146 from field device 120 using transceiver 182. Processor 180 stores the current display features received from field device 120 to display features 340 of memory 190 (block 412). Processor 180 determines a field device type 346 from data associated with the display features 146 from among several field device types (block 414).

Processor 180 generates a display window (i.e. DW 1 252) including GUI data 254 and the user control data 350 based at least partially on the determined field device type 346 and placement information 230 (block 416). Processor 180 displays the DW 1 252 including the GUI data 254 and the user control data 350 in respective locations on mobile display 152 based on the placement information 230 (block 418). Method 400 then ends.

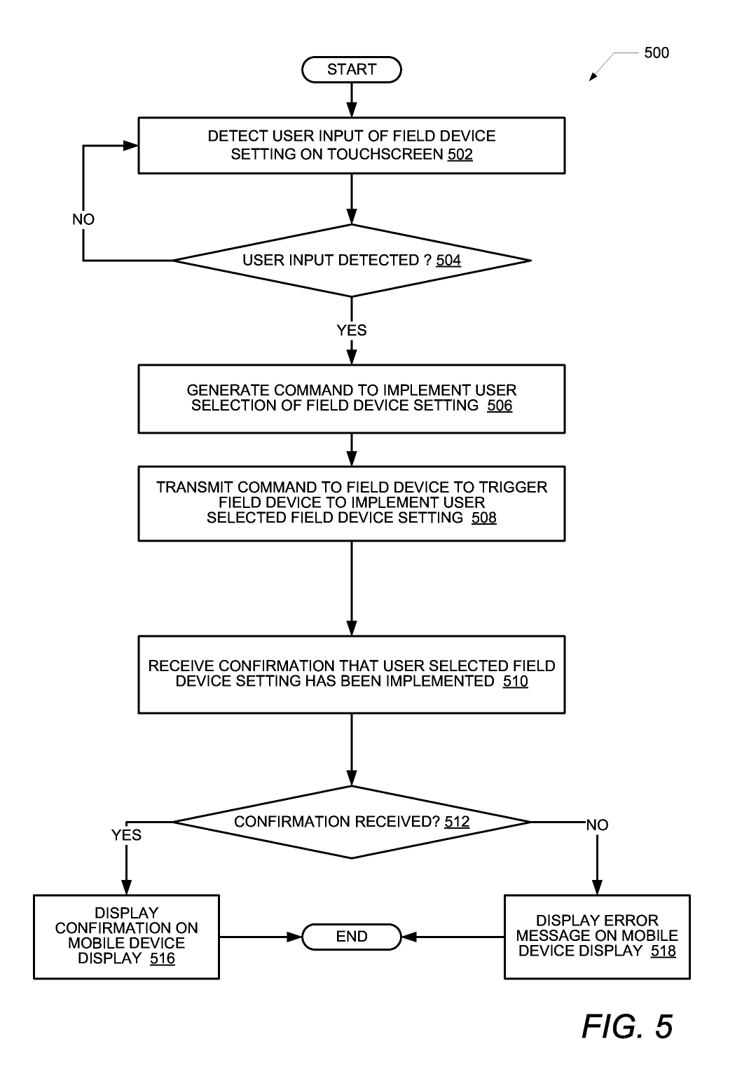

FIG. 5 is a flow chart showing steps in an example method 500 for a user to select field device settings 360 using mobile device 150. Method 500 can be implemented via the execution of FD emulation program 192 by processor 180. Method 500 begins at the start block and proceeds to block 502 where processor 180 detects if a user has input at least one field device settings 360 using a touch sensitive screen such as mobile display 152. Using mobile display 152, a user can alter the emulated user input controls shown within the display window 252 of mobile display 152. Field device settings 360 are user selected values input by user on mobile device 150 for transmission to field device 120. After transmission of the field device settings 360 to field device 120, field device 120 changes any one of user controls 136 or other parameters to match the selected field device settings.

At decision block 504, processor 180 determines if a user input for at least one field device settings 360 has been received. In response to no user input for at least one field device settings 360 having been received. Method 500 returns to block 502 to continue detecting user input for field device settings 360. In response to user input for at least one field device settings 360 having been received, processor 180 generates a command to implement the selected field device settings 360 on field device 120 (block 506). Processor 180 wirelessly transmits or sends, via transceiver 182, the command including the field device settings 360 to field device 120 (block 508).

The field device 120 implements the command to change the user controls 136 to match the received field device settings 360 and transmits a confirmation the field device settings have been implemented. Processor 180 receives confirmation data from field device 120, via transceiver 182, that the field device settings 360 have been implemented in field device 120 (block 510). At decision block 512, processor 180 determines if the confirmation data from the field device has been received. In response to the confirmation data from the field device not having been received, processor 180 displays an error message on mobile display 152 (block 518). In response to the confirmation data from the field device having been received, processor 180 displays a message on mobile display 152 that the user selected field device settings 360 have been implemented in field device 120 (block 516). Method 500 then ends.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

1. A method, comprising:
providing a mobile device including a mobile display, a transceiver coupled to an antenna, a non-transitory machine readable storage device (memory device), and at least one processor coupled to said mobile display and said transceiver, wherein said memory device stores a display emulation program implemented by said processor, said display emulation program implementing:
wirelessly sending a request for current information describing display features (current display features) displayed on a field device display (FDD) of a field device within an industrial process facility, wherein said display features include at least one display window having graphical unit interface (GUI) process data therein associated with said field device, at least one user control for controlling said field device, and placement information defining locations on said FDD for said display window, said GUI process data, and said user control;
wirelessly receiving said current display features from said field device, and
displaying said display window including said GUI process data therein and said user control in respective locations on said mobile display based on said placement information.

2. The method of claim 1, wherein said field device comprises an industrial control device or measurement device.

3. The method of claim 1, wherein said request further includes requestor identification information.

4. The method of claim 1, wherein said at least one display window comprises a plurality of said display windows.

5. The method of claim 1, wherein said current display features are updated in real-time.

6. The method of claim 1, wherein said current display features further comprise:
at least one visual indicator;
at least one alarm; and
at least one status and/or event indicator.

7. The method of claim 1, wherein wirelessly receiving said current display features from said field device further comprises:
determining a field device type from data associated with said current display features from among a plurality of field device types; and
configuring said display window at least partially based on said field device type.

8. The method of claim 1, wherein said mobile display includes a touch sensitive screen portion for said user control.

9. The method of claim 8, further comprising:
receiving a user input selection of a first field device setting for said field device via said touch sensitive screen portion;
generating a command to implement said first field device setting on said field device; and
wirelessly sending, via said transceiver, said command to said field device.

10. The method of claim 9, further comprising:
receiving confirmation data from said field device that said first field device setting has been implemented in said field device.

11. A mobile device comprising:
a mobile display;
a transceiver coupled to an antenna;
at least one processor coupled to said mobile display and said transceiver; a non-transitory machine readable storage device (memory device) coupled to said processor, wherein said memory device stores a display emulation program implemented by said processor, said display emulation program causing said processor to:
wirelessly send a request for current information describing display features (current display features) displayed on a field device display (FDD) of a field device within an industrial process facility, wherein said display features include at least one display window having graphical unit interface (GUI) process data therein associated with said field device, at least one user control for controlling said field device, and placement information defining locations on said FDD for said display window, said GUI process data, and said user control;
wirelessly receive said current display features from said field device, and
display said display window including said GUI process data therein and said user control in respective locations on said mobile display based on said placement information.

12. The mobile device of claim 11, wherein said field device comprises an industrial control device or measurement device.

13. The mobile device of claim 11, wherein said request further includes requestor identification information.

14. The mobile device of claim 11, wherein said at least one display window comprises a plurality of said display windows.

15. The mobile device of claim 11, wherein said current display features are updated in real-time.

16. The mobile device of claim 11, wherein said current display features further comprise:
at least one visual indicator;
at least one alarm; and
at least one status and/or event indicator.

17. The mobile device of claim 11, wherein wirelessly receiving said current display features from said field device further comprises said display emulation program causing said processor to:
determine a field device type from associated with said current display features from among a plurality of field device types; and
configure said display window at least partially based on said field device type.

18. The mobile device of claim 11, wherein said mobile display includes a touch sensitive screen portion for said user control.

19. The mobile device of claim 18, wherein said display emulation program further causes said processor to:
receive a user input selection of a first field device setting for said field device via said touch sensitive screen portion;
generate a command to implement said first field device setting on said field device; and
wirelessly send, via said transceiver, said command to said field device.

20. The mobile device of claim 19, wherein said display emulation program further causes said processor to:
receive confirmation data from said field device that said first field device setting has been implemented in said field device.
